(19) United States
(12) Patent Application Publication
(10) Pub. No.: US 2015/0042621 A1
(43) Pub. Date: Feb. 12, 2015

(54) METHOD AND APPARATUS FOR CONTROLLING 3D OBJECT

(71) Applicant: Samsung Electronics Co., Ltd., Gyeonggi-do (KR)

(72) Inventor: Grzegorz Grzesiak, Warsaw (PL)

(21) Appl. No.: 14/455,686

(22) Filed: Aug. 8, 2014

(30) Foreign Application Priority Data
Aug. 8, 2013 (KR) 10-2013-0093907

(51) Int. Cl. G06F 3/042

(52) U.S. Cl. CPC G06F 3/0421
USPC 345/175

(57) ABSTRACT

A method for controlling a 3D objects includes photographing an image of an external object that operates 3D objects displayed in a user device, extracting, from the obtained image, one or more feature points included in the external object, determining, from the extracted feature points, one or more effective feature points used in operation the 3D objects; and tracing the determined effective feature points to sense an input event associated with the operation of the 3D object. An apparatus includes a camera configured to obtain an image of an external object for operating 3D objects, and a controller configured to extract feature points of the external object from the obtained image, determine one or more effective feature points used in operation the 3D objects from the extracted feature points, and trace the determined effective feature points to sense an input event associated with the operation of the 3D objects.

### CROSS-REFERENCE TO RELATED APPLICATIONS AND CLAIM OF PRIORITY

The present application is related to and claims the priority under 35 U.S.C. §119(a) to Korean Application Serial No. 10-2013-0093907, which was filed in the Korean Intellectual Property Office on Aug. 8, 2013, the entire content of which h is hereby incorporated by reference.

### TECHNICAL FIELD

The present invention relates to a method and an apparatus for controlling a 3D object, and more particularly to, a method and an apparatus for controlling an object displayed based on 3D in a proximity range.

### BACKGROUND

Technologies about user devices have been rapidly developed. Particularly, user devices that are portable by users, such as a smart phone and the like, are provided with various applications. The user devices provide useful services to users through the applications.

With respect to services through applications, endeavors to improve user convenience have been continuously made. These endeavors cover structural modification or improvement of components constituting the user device as well as improvement of software or hardware. Of these, a touch function of the user device enables even a user who is unfamiliar with button input or key input to conveniently operate the user device by using a touch screen. Recently, the touch function has been recognized as an important function of the user device together with a User Interface (UI), beyond simple input.

However, the conventional touch function was developed considering only when the user interface is displayed based on 2D, and thus cannot efficiently act on a user interface displayed in the user device based on 3D.

Moreover, when there are a plurality of external objects operating the user interface or a plurality of pointers displayed on the user interface depending on the plurality of external objects, the user device of the conventional art cannot recognize all of them to operate the user interface for respective events individually. Also, the user interface can only be operated when the external object is directly contacted with a touch screen or the external object is very adjacent to the user interface, and thus the user interface cannot be operated when the external object is a relatively long way from the user device.

### SUMMARY

To address the above-discussed deficiencies, it is a primary object to provide a method for controlling a 3D object, capable of individually operating 3D objects, which are displayed based on 3D, in a proximity range by using effective feature points.

Another aspect of the present invention is to provide an apparatus for controlling a 3D object, capable of individually operating 3D objects, which are displayed based on 3D, in a proximity range by using effective feature points.

In accordance with an aspect of the present invention, a method for controlling a 3D object is provided. The method includes obtaining an image of the external object for operating at least one 3D object displayed in a user device, extracting one or more feature points of the external object from the obtained image, determining one or more effective feature points used for operating the at least one 3D object from the extracted feature points, and tracing the determined effective feature points to sense an input event of the external object.

In accordance with another aspect of the present invention, an apparatus for controlling a 3D object is provided. The apparatus includes: a camera module that obtains an image of an external object for operating 3D objects, and a controller configured to extract, one or more feature points included in the external object from the obtained image; determine one or more effective feature points used in operation the 3D objects from the extracted feature points, and trace the determined effective feature points to sense an input event associated with the operation of the 3D objects.

According to an embodiment of the present invention, a plurality of objects displayed based on 3D can be individually and simultaneously operated by using respective effective feature points, which are some of feature points of the external object, as pointers for operating the 3D objects.

Further, in the user device based on a touch gesture, the objects displayed in the user device can be operated even while the external object is not contacted with the touch screen.

Effects of the preset invention are not limited to the foregoing effects, and various effects are inherent in the present specification.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a schematic diagram of a user device according to an embodiment of the present invention;

FIG. 2 is a flowchart illustrating a method for controlling a 3D object according to an embodiment of the present invention;

FIGS. 3A and 3B are conceptual views illustrating a first case in which feature points and effective feature points of an external object are determined, according to an embodiment of the present invention;

FIGS. 4A and 4B are conceptual views illustrating a second case in which feature points and effective feature points of an external object are determined, according to an embodiment of the present invention;

FIGS. 5A and 5B are conceptual views illustrating a case in which a 2D page and a 3D page are switched with each other, according to an embodiment of the present invention;

FIG. 6 is a conceptual view illustrating a case in which effective feature points are displayed as 3D indicators in a user device, according to an embodiment of the present invention;

FIG. 7 is a conceptual view illustrating a case in which effective feature points move according to motion of an external object while the effective feature points are displayed as 3D indicators in a user device, according to an embodiment of the present invention;

FIG. 8 is a conceptual view illustrating a case in which a 3D object is operated by an external object, according to an embodiment of the present invention;

FIG. 9 is a flowchart illustrating a first case in which effective feature points are positioned on a target 3D object, according to an embodiment of the present invention;

FIG. 10 is a flowchart illustrating a second case in which effective feature points are positioned on a target 3D object, according to an embodiment of the present invention;

FIGS. 11A and 11B are conceptual views illustrating the first case in which effective feature points are positioned on a target 3D object, according to an embodiment of the present invention; and

FIGS. 12A and 12B are conceptual views illustrating the second case in which effective feature points are positioned on a target 3D object, according to an embodiment of the present invention.

### DETAILED DESCRIPTION

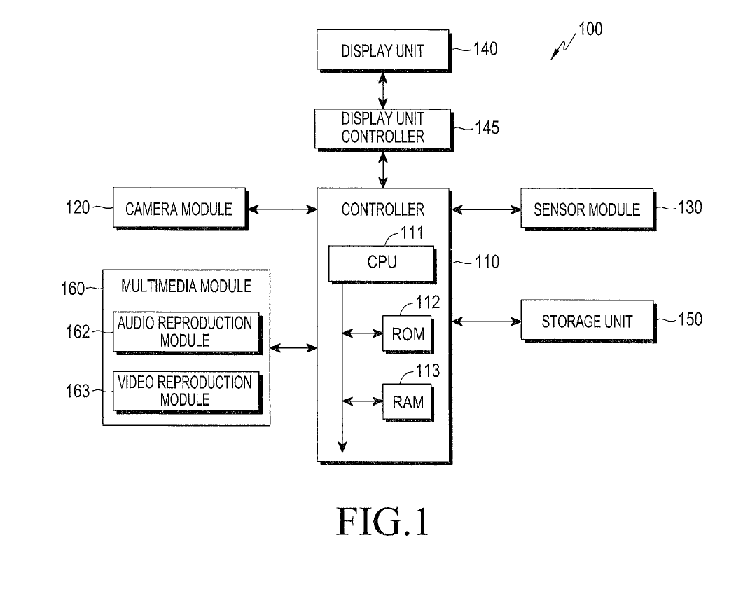

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic devices. Various example embodiments will now be described more fully with reference to the accompanying drawings in which some example embodiments are shown. However, the embodiments do not limit the present invention to a specific implementation, but should be construed as including all modifications, equivalents, and replacements included in the spirit and scope of the present invention.

While terms including ordinal numbers, such as “first” and “second,” etc., may be used to describe various components, such components are not limited by the above terms. The terms are used merely for the purpose to distinguish an element from the other elements. For example, a first element could be termed a second element, and similarly, a second element could be also termed a first element without departing from the scope of the present invention. As used herein, the term “and/or” includes any and all combinations of one or more of the associated listed items.

The terms used in this application is for the purpose of describing particular embodiments only and is not intended to be limiting of the invention. As used herein, the singular forms are intended to include the plural forms as well, unless the context clearly indicates otherwise. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

Unless defined otherwise, all terms used herein have the same meaning as commonly understood by those of skill in the art. Such terms as those defined in a generally used dictionary are to be interpreted to have the meanings equal to the contextual meanings in the relevant field of art, and are not to be interpreted to have ideal or excessively formal meanings unless clearly defined in the present specification.

A user device according to an embodiment of the present invention is preferably a smart phone, but is not limited thereto. That is, the user device can include a personal computer, a smart TV, and the like. Hereinafter, there will be described as an example a case in which the user device is a smart phone by an example.

FIG. 1 is a block diagram schematically illustrating a user device according to an embodiment of the present invention

Referring to FIG. 1, a user device 100 can include a controller 110, a camera module 120, a sensor module 130, a display unit 140, a display unit controller 145, a storage unit 150, and a multimedia module 160. The multimedia module 160 can include an audio reproduction module 162 or a video reproduction module 163.

The controller 110 can include a Central Processing Unit (CPU) 111, a Read-Only Memory (ROM) 112 in which control programs for controlling the user device 100 are stored, and a Random-Access Memory (RAM) 113 which stores signals or data input externally from the user device 100 or is used as a memory region for an operation executed in the user device 100. The CPU 111 can include a single core, a dual core, a triple core, or a quad core. The CPU 111, the ROM 112 and the RAM 113 can be connected with each other through internal buses.

The controller 110 can control the camera module 120, the sensor module 130, the display unit controller 145, the storage unit 150, and the multimedia module 160. The controller 110 can extract one or more feature points 210 included in the external object 200 from an image photographed by the camera module 120, determine one or more effective feature points 210c, which are used in operation for 3D objects 300a, 300b, and 300c, from the extracted feature points, and trace the effective feature points 210 to sense an input event associated with operation of the 3D objects 300a, 300b, and 300c. In addition, the controller 110 can switch from 2D indicators 210b of the effective feature points 210 to 3D indicators 210d thereof by using depth information obtained by the camera module 120 or the sensor module 130. For achieving this, the controller 110 can calculate depth coordinates for an image of the external object 200 by using the depth information obtained by the camera module 120 or the sensor module 130.

The camera module 120 can include a camera photographing still images or moving images according to the control of the controller 110. In addition, the camera module 120 can include an auxiliary light source (e.g., a flash (not shown) providing a necessary amount of light for photographing.

The camera module 120 can be composed of one camera or a plurality of cameras. The camera module 120 as one example of the present invention can be preferably a camera that photographs images by using a Time of Flight (ToF) method (hereinafter, referred to as “ToF camera” when necessary) or a camera that photographs images by using a stereoscopic method (hereinafter, referred to as “stereoscopic camera” when necessary). However, examples of the camera module 120 are not limited thereto. That is, it will be obvious to those skilled in the art that the examples of the camera module 12 are not limited to the ToF camera or the stereoscopic camera as long as the camera module can photograph the image of the external object 200 and include a depth sensor capable of obtaining depth information on the photographed image. However, the depth sensor may not be included in the camera module 120 but can be included in the sensor module 130. The camera module 120 can include a plurality of neighboring cameras in the case in which the camera module 120 employs the stereoscopic method. The ToF camera or stereoscopic camera will be described later.

The sensor module 130 includes at least one sensor that detects the state of the user device 100. For example, the sensor module 130 includes a proximity sensor for detecting whether the user approaches the user device 100 and a luminance sensor for detecting the amount of light around the user device 100. Also, the sensor module 130 can include a gyro sensor. The gyro sensor can detect the operation of the user device 100 (e.g., rotation of the user device 100, or acceleration or vibration applied to the user device 100), detect a point of the compass by using the magnetic field on Earth, or detect the acting direction of gravity. The sensor module 130 can include an altimeter that detects the altitude by measuring the atmospheric pressure. The at least one sensor can detect the state, generate a signal corresponding to the detection, and transmit the generated signal to the controller 110. The at least sensor in the sensor module 130 can be added or omitted according to the performance of the apparatus 100.

The sensor module 130 can include a sensor that measures the distance between the external object 200 and the user device 100. The controller 110 can control 2D indicators 210a and 210b or 3D indicators 210d to be displayed or not to be displayed in the user device 100, based on the distance information between the external object 200 and the user device 100, which is obtained by the sensor module 130. For example, the sensor module 130 can determine whether the distance between the user device 100 and the external object 200 falls within a predetermined proximity range, and the controller 110 can control the 2D indicators 210a and 210b or the 3D indicators 210d to be displayed or not to be displayed on the display unit 140 according to whether the distance falls within the proximity range. For achieving this, the sensor module 130 can preferably include at least one ultrasonic sensor, but the ultrasonic sensor is merely given for an example, and thus other kinds of sensors that measure the distance are not excluded.

The display unit 140 can provide user interfaces corresponding to various services (e.g., phone communication, data transmission, broadcasting, and photographing a picture) to the user. When the display unit 140 is composed of a touch screen, the display unit 140 can transmit, to the display unit controller 145, an analog signal corresponding to at least one touch input to a user interface. The display unit 190 can receive at least one touch through a body part of a user (e.g., fingers including a thumb) or a touchable external object (e.g., a stylus pen). Herein, there will be described as an example a case in which the display unit 140 is a touch screen as a preferable example thereof. However, the display unit 140 is not limited thereto.

The display unit 140 can receive successive motions of one touch in at least one touch. The display unit 140 can transmit, to the display unit controller 145, an analog signal corresponding to the successive motions the touch input thereto. In the present invention, the touch is not limited to a contact between the display unit 140 and the body of the user or a touchable external object, and can include a non-contact touch. The detectable interval in the display unit 140 can be changed according to the performance or structure of the sensor module 130.

The display unit 140 can be implemented in, for example, a resistive type, a capacitive type, an infrared type, or an acoustic wave type.

The display unit controller 145 converts the analog signal received from the display unit 140 to a digital signal (e.g., X and Y coordinates) and transmits the digital signal to the controller 110. The controller 110 can control the display unit 140 by using the digital signal received from the display unit controller 145. For example, the controller 110 can control a shortcut icon (not shown) displayed on the display unit 140 to be selected or can execute the shortcut icon (not shown) in response to a touch. Further, the display unit controller 145 can be included in the controller 110.

The controller 150 can store signals or data input/output in response to operations of the camera module 120, the sensor module 130, the display unit controller 145, the storage unit 150, and the multimedia module 160. The storage unit 150 can store control programs and applications for controlling the user device 100 or the controller 110.

The term “storage unit” includes the storage unit 150, the ROM 112 or the RAM 113 within the controller 110, or a memory card (not shown) (for example, an SD card or a memory stick) mounted to the user device 100. The storage unit 150 can include a nonvolatile memory, a volatile memory, a Hard Disk Drive (HDD), or a Solid State Drive (SSD).

The multimedia module 160 can include the audio reproduction module 162 or the video reproduction module 164. The audio reproduction module 162 can reproduce a digital audio file (e.g., a file having a filename extension of mp3, wma, ogg, or way) stored or received according to the control of the controller 110. The video reproduction module 164 can reproduce a digital video file (e.g., a file having a file extension of mpeg, mpg, mp4, avi, mov, or mkv) stored or received according to the control of the controller 110. The video reproduction module 164 can reproduce the digital audio file. The audio reproduction module 162 or the video reproduction module 164 can be included in the controller 110.

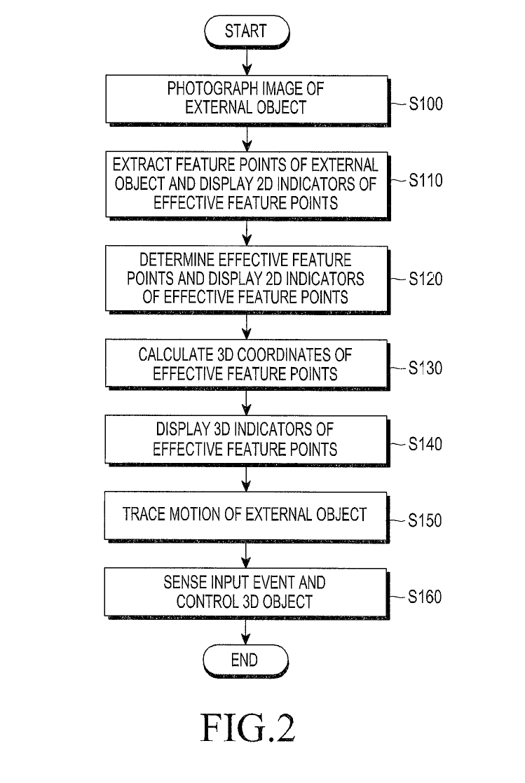

FIG. 2 is a flowchart illustrating a method for controlling a 3D object according to an embodiment of the present invention.

Referring to FIG. 2, in a method for controlling 3D objects 300a, 300b, and 300c according to an embodiment of the present invention, the user device can photograph an image of the external object 200 (S100), and extract feature points 210 of the external object 200 and display 2D indicators 210b of the feature points 210 (S110).

The external object 200 can be a unit for controlling the 3D objects 300a, 300b, and 300c displayed on the display unit 140 of the user device 100. The external object 200 as an example of the present invention can be preferably a hand of a user, but is not limited thereto, and can include various shaped objects. That is, since the present invention controls the 3D objects 300a, 300b, and 300c based on the feature points extracted from the shape of the external object 200, the external object 200 needs not be a touch input-able unit (e.g., a stylus pen used in a touch screen, etc.). The foregoing constitution can lead to an improvement in convenience of the user using the user device 100 according to the embodiment of the present invention. Herein, for convenience of explanation, there will be described as an example a case in which the external object 200 is a hand of a user.

The step of photographing the image of the external object 200 (S100) can be conducted by using the ToF camera or the stereoscopic camera as mentioned above. The ToF camera means a camera that measures the flight time, that is, the traveling time of the light projected on and then reflected from an object and then calculates a distance. The stereoscopic camera means a camera that uses two images for the left eye and the right eye to create binocular disparity to give a three-dimensional effect to a subject, that is, the external object 200. The meanings of the ToF camera and the stereoscopic camera will be clearly understood by those skilled in the art. In addition to the obtained depth information, the camera module 120 can generate color data in the same manner as the conventional color camera, and the data can be combined with the depth information so as to process the image of the external object 200.

In the step of extracting the feature points of the external object 200, the feature points 210 of the external object 200 can be extracted by using the conventional various methods or algorithms, such as an Active Shape Model (ASM) or the like. The feature points 210 of the external object 200 can correspond to a finger end, a palm crease, a finger joint, or the like. As described later, the controller 110 can be configured to extract the feature points 210 of the external object 200. When the feature points 210 of the external object 200 are extracted, 2D indicators 210a of the feature points 210 can be displayed on the display unit 140 of the user device 100. Accordingly, the user of the user device 100 can visually confirm the external object 200.

After displaying the 2D indicators 210b of the feature points 210 of the external object 200, the user device 100 can determine effective feature points 210c, and display the 2D indicators 210b of the effective feature points 210c on the display unit 140. The effective feature point 210c mentioned herein can mean, from among the extracted feature points 210, a “point” that can be used in operation of the 3D objects 300a, 300b, and 300c. For example, the effective feature point 210c can perform a function like in the stylus pen. As for the method for controlling a 3D object according to an embodiment of the present invention, when the number of effective feature points is plural in number, the respective effective feature points 210c can be individually controlled. When the number of effective feature points 210c is 5, the controller 110 can recognize all five effective feature points 210c to exhibit such an effect that five stylus pens can operate the 3D objects 300a, 300b, and 300c, respectively.

For reference, the “operation” mentioned herein can be meant to include operations expectable by those skilled in the art for objects displayed in the user device, such as touch, position shift, copy, deletion, and the like, for the 3D objects 300a, 300b, and 300c. In addition, the “operation” can include a motion of grabbing the 3D objects 300a, 300b, and 300c displayed on the display unit 140 by the hand, a motion of moving the 3D objects 300a, 300b, and 300c inward in a 3D space so as to cause the 3D objects 300a, 300b, and 300c to be further away from the user on the display unit 140 based on the user. That is, it should be understood that the “position shift” is meant to include a position shift that is conducted in a 3D space as well as a position shift that is conducted on a 2D plane, and that the “touch” can be meant to include a space touch that is conducted in a space as well as a touch that is conducted on a plane.

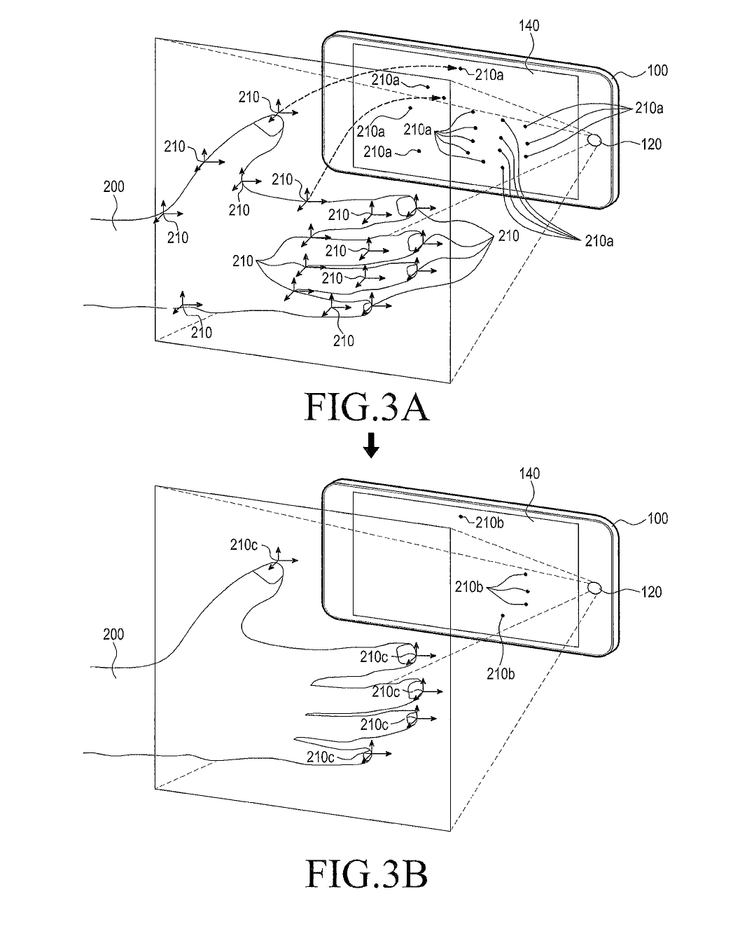

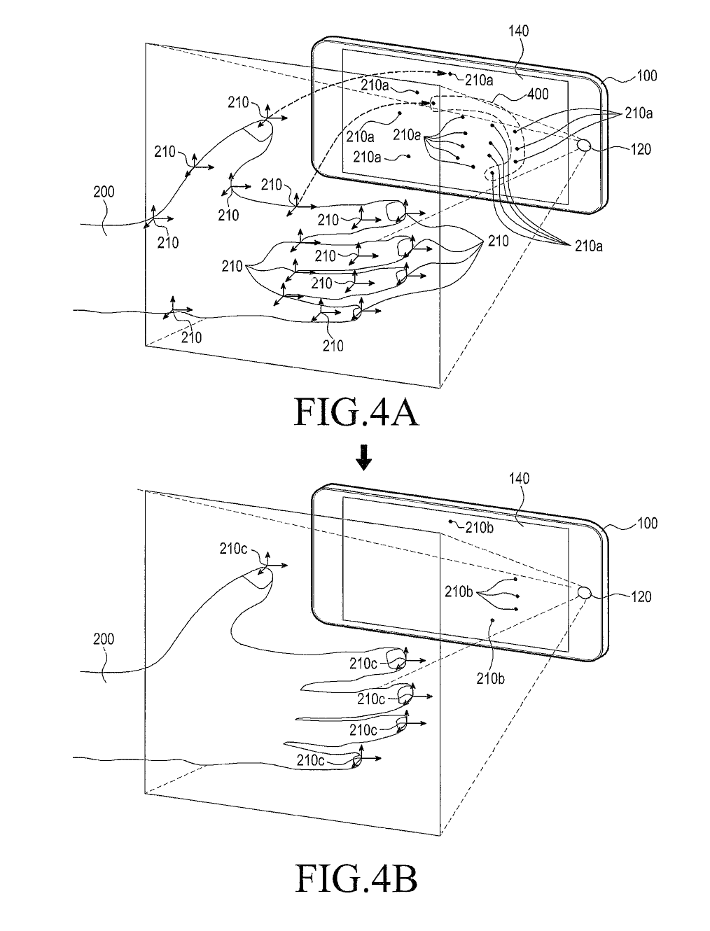

With respect to the determining of the effective feature points 210c according to an embodiment of the present invention, the controller 110 can determine the effective feature points 210c depending on the shape of the external object 200, irrespective of an intention of a user, or the user can determine the effective feature points 210c. Related cases are shown in FIGS. 3 and 4.

Referring to FIG. 3A, the feature points 210 of the external object 200 can be displayed as the 2D indicators 210a on the display unit 140 of the user device 100. The hand of the user as the external object 200 can include a plurality of various feature points 210. Referring to (b) of FIG. 3, a first example of a case in which the effective feature points 210c are determined is shown. The effective feature points 210c are determined from the plurality of feature points 210 depending on the shape of the external object 200. As shown in FIG. 3B, the user device 100 can determine finger ends of the user as the effective feature points 210c. Information on which portions of the external object 200 are determined as the effective feature points 210c depending on the shape of the external object 200 can be in advance set and stored in the storage unit 150. Alternatively, the controller 110 can analyze the shape of the external object 200 in real time to arbitrarily determine, for example, end portions of the external object 200 as the effective feature points 210c. That is, the present invention can further improve convenience of user as compared with the conventional art by performing a kind of “filtering” process in which the effective feature points 210c are set from a plurality of feature points 210, reflecting on the shape of the external object 200 or the intent of the user.

Referring to FIG. 4A, the feature points 210 of the external object 200 can be displayed as the 2D indicators 210a on the display unit 140 of the user device 100, like in the case shown in FIG. 3A. However, unlike in the case shown in FIGS. 3A and 3B, the user can determine the effective feature points 210c. That is, referring to FIG. 4A, the user can select an area 400 including feature points to be used as the effective feature points 210c among the 2D indicators 210a for the plurality of feature points 210. When the display unit 140 is configured by a touch screen, the user can draw the area 400 including feature points, thereby selecting the area 400. When the display unit is not configured by the touch screen, the area 400 including feature points can be selected through another input and output interface (e.g., a mouse or the like). When the area 400 including feature points is determined by the user, the feature points included in the area 400 can be set as effective feature points 210c. As shown in FIGS. 4A and 4B, only the selected effective feature points 210c can be displayed on the display unit 140. The 2D indicators 210a and 210b displayed on the display unit 140 are shown in a circular shape in the drawing, but this is given for an example and thus it is obvious to those skilled in the art that the shape of the 2D indicators 210a and 210b is not limited thereto.

Then, the user device 100 can calculate 3D coordinates of the effective feature points 210c, and display 3D indicators 210d of the effective feature points 210c based on the calculation results (S130 and S140). In order to display the 3D indicators 210d, the controller 110 can calculate the 3D coordinates of the effective feature points 210c to display the 3D indicators 210d without separate operations of the user, or can display the 3D indicators 210d according to whether the selection by the user with respect to displaying or non-displaying of the 3D indicators 210d is input. When the 3D indicators 210d are to be displayed in response to the selection of the user to display or not to display the 3D indicators 210d, a separate User Interface (UI) for receiving the selection of the user can be displayed on the display unit 140.

The controller 110 of the user device 100 can calculate the 3D coordinates based on depth information of the external object, which is obtained by the camera module 120 or the sensor module 130. The depth information can be defined as depth data for each pixel of the photographed image, and the depth can be defined as a depth between the external object 200 and the camera module 120 or the sensor module 130. Therefore, so long as the external object 200 is positioned in a proximity range based on the user device 100 even while the user device 100 and the external object 200 are directly contacted with each other, the 3D objects 300a, 300b, and 300c can be operated by using the effective feature points 210c displayed based on 3D.

As used herein, the term “proximity range” generally refers to a personalized space or area in which the user can interact with the user device 100. Therefore, the depth information or depth image can be obtained in a range of, for example, 20 cm to 60 cm. In addition, as another example, the depth information or depth image can be obtained in a range of, for example, 0 m to 3.0 m. In some embodiments, it is obvious to those skilled in the art that the depth information or depth image can be obtained from a distance longer than 3.0 m depending on the photographing environment, the size of the display unit 140, the size of the user device 100, the resolution of the camera module 120 or the sensor module 13, the accuracy of the camera module 120 or the sensor module 130, or the like.

Then, the user device 100 can trace motion of the external object 200, sense an input event input by the external object 200, and control the 3D objects 300a, 300b, and 300c in response to the input event (S150 and S160). Herein, a 3D object which is operated or expected to be operated in response to the input event is called a target 3D object 300a.

The motion of the external object 200 can be traced by the camera module 120 when the camera module 120 capable of obtaining the depth information is included in the user device 100, or by the camera module 120 and the sensor module 130 when a separate sensor capable of obtaining the depth information is included in the sensor module 130.

The input event can include any one of a touch, a tap, a swipe, a flick, and a pinch for the 3D objects 300a, 300b, and 300c or a page on which the 3D objects 300a, 300b, and 300c are displayed. For reference, it should be understood that the term touch as mentioned herein includes a direct contact of the external object 200 with the display unit 140 as well as a space touch conducted by the 3D objects 300a, 300b, and 300C or by the effective feature points 210c on the 3D page on which the 3D objects 300a, 300b, and 300C are displayed even without the direct contact between the external object 200 and the display unit 140. Also, it should be understood that the terms “tap”, “swipe”, “flick”, and “pinch” include those conducted on the 3D space displayed on the display unit 140 in the same concept as the foregoing “touch”. The input event includes, in addition to the foregoing examples, all operations for the 3D objects 300a, 300b, and 300c, which are expectable by those skilled in the art, such as grab, drag and drop, and the like, for the 3D objects 300a, 300b, and 300c. The meanings of the touch, tap, swipe, flick, pinch, grab, and drag and drop will be clearly understood by those skilled in the art.

The 3D objects 300a, 300b, and 300c displayed on the display unit 140 can be individually operated by at least one effective feature point 210c. That is, the number of target 3D objects 300a can be plural in number. Regarding to the above description, the term “individually operated” or “individually controlled” as used herein needs to be construed as the meaning that the plurality of 3D objects 300a, 300b, and 300c each can be independently operated through the respective effective feature points 210c.

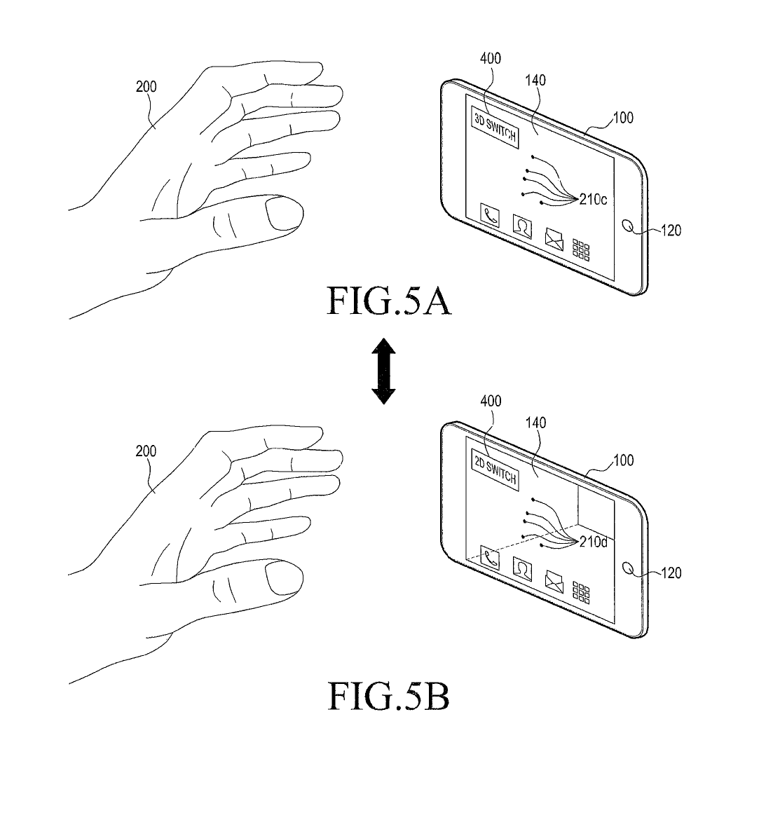

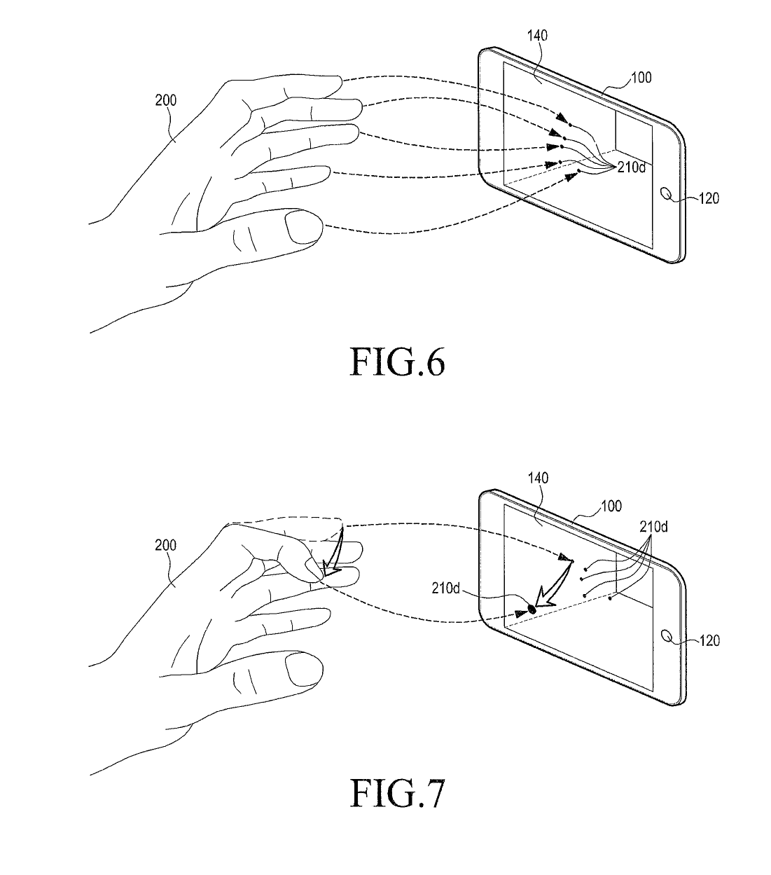

FIGS. 5A and 5B are conceptual views illustrating a case in which a 2D page and a 3D page are switched with each other according to an embodiment of the present invention; FIG. 6 is a conceptual view illustrating a case in which effective feature points are displayed as 3D indicators in a user device according to an embodiment of the present invention; and FIG. 7 is a conceptual view illustrating a case in which effective feature points move according to motion of an external object while the effective feature points are displayed as 3D indicators in a display device according to an embodiment of the present invention.

Referring to FIGS. 5 and 6, the user can touch a switch selection UI 500, in order to switch from the 2D indicators 210b of the effective feature points 210c, which are displayed on the display unit 140, into the 3D indicators 210d thereof, which are displayed on the 3D page. A case in which the 2D indicators 210b of the effective feature points 210c are displayed on the 2D page is shown in FIG. 5A; a case in which the 3D indicators 210d of the effective feature points 210c are displayed on the 3D page is shown in FIG. 5B. When a switch selection signal by the user is received, the obtained depth information is used to calculate 3D coordinates of the effective feature points 210c of the external object 200 and thus generate the 3D indicators 210d. On the contrary to this, also when the user desires to switch from the 3D page into the 2D page again, the user can touch the switch selection UI 500 to implement a switch into the 2D page on which the 2D indicators 210b are displayed. However, the switch between the 2D page and the 3D page through this method needs to be construed as an example, but not excluding a case in which the controller 110 automatically performs the switch irrespective of the input of the switch selection by the user. For example, the controller 110 can control to display the 2D indicators of the effective feature points 210c and immediately display the 3D indicators thereof, or automatically perform the switch into the 2D page on which the 2D indicators are displayed when a particular input from the user is not received on the 3D page for a predetermined time. FIG. 6 is a conceptual view illustrating a case in which the 3D indicators 210d corresponding to the effective feature points 210c are displayed on the 3D page displayed on the display unit 140.

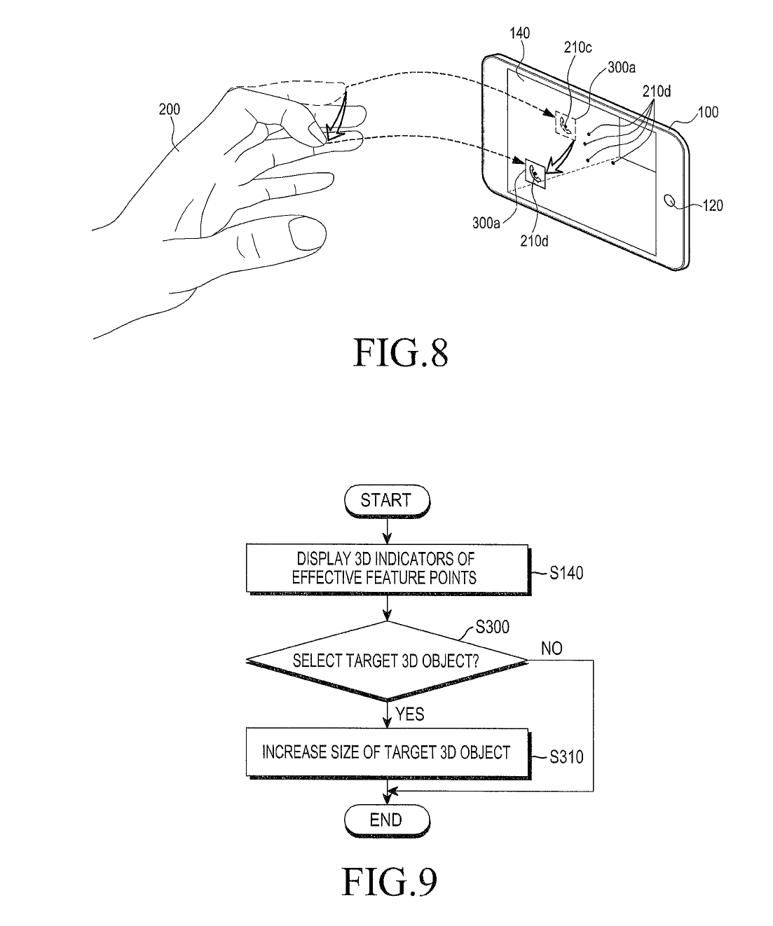

Referring to FIG. 7, when the external object 200, that is, a hand of the user moves so as to operate the 3D indicators 210d while the 3D indicators 210d are displayed, the controller 110 can trace the motion of the hand of the user and then control to move the 3D indicators 210d according to the motion of the hand of the user. As an example, when the 3D indicators 210d move toward the user based on the user, the sizes of the 3D indicators 210d can be increased. By using this, the user can operate the target 3D object 300a, as shown in FIG. 8.

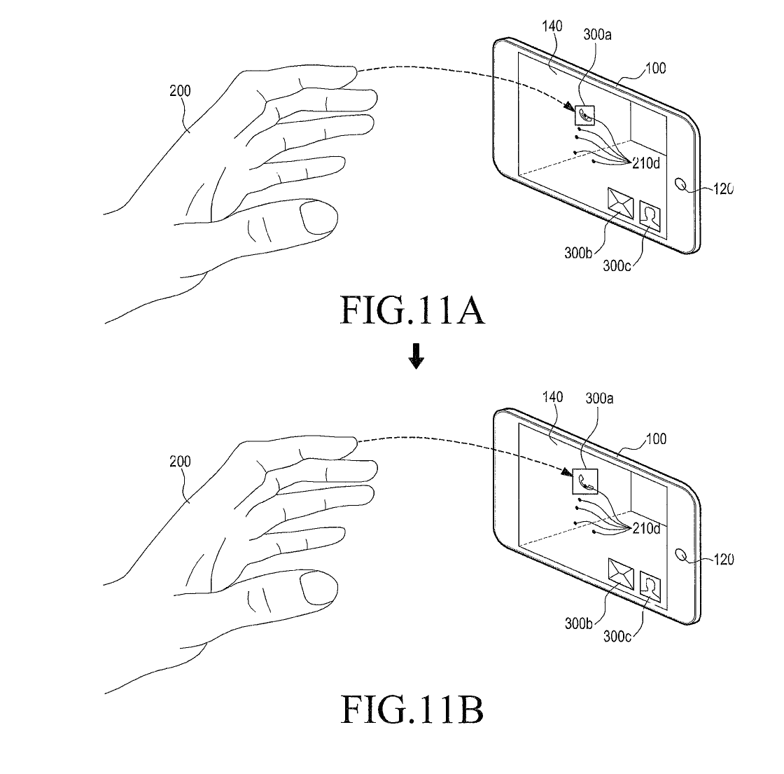

FIG. 9 is a flowchart illustrating a first case in which effective feature points are positioned on a target 3D object according to an embodiment of the present invention. FIGS. 11A and 11B are a conceptual view illustrating the first case in which effective feature points are positioned on a 3D object according to an embodiment of the present invention.

Referring to FIGS. 9 and 11, the user device 100 can display 3D indicators of effective feature points (S140), determine whether the target 3D object is selected (S300), and increase the size of the target 3D object 300a when the target 3D object is selected (S310). Herein, the “selection” can means, preferably, a case in which a space touch on the target 3D object 300a is conducted, but not excluding a case in which 3D indicators 210d of the effective feature points 210c are positioned on the target 3D object 300a in response to another input event. In addition, when the 3D indicators 210d are positioned in a predetermined range around respective 3D objects 300a, 300b, and 300c, the 3D objects 300a, 300b, and 300c are expected to be selected, and thus the controller 110 can determine the 3D objects 300a, 300b, and 300c as being selected as a target object 300a, and thus control to increase the size of the target object 300a.

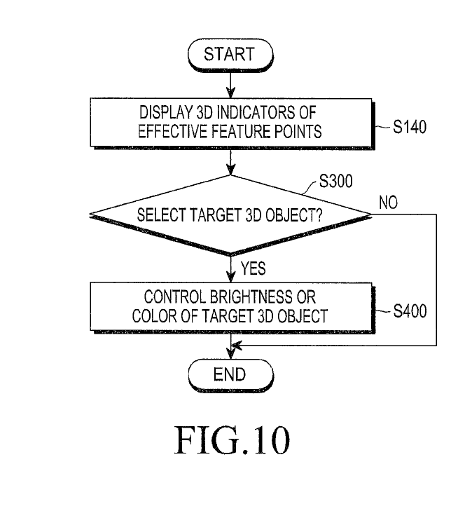

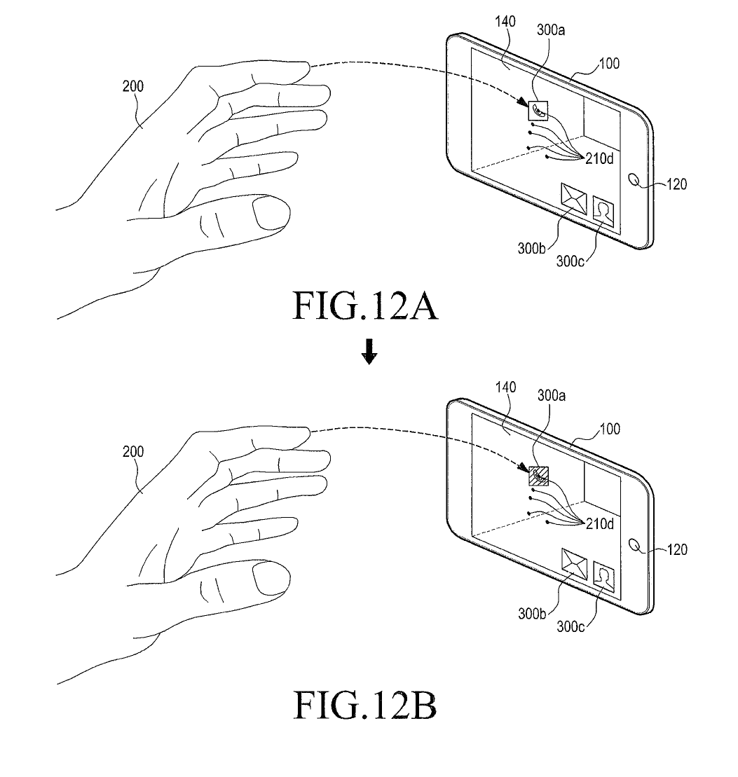

FIG. 10 is a flowchart illustrating a second case in which effective feature points are positioned on a target 3D object according to an embodiment of the present invention. FIGS. 12A and 12B are conceptual views illustrating the second case in which effective feature points are positioned on a 3D object according to an embodiment of the present invention.

Referring to FIGS. 10 and 12, the user device 100 can display 3D indicators of effective feature points (S140), determine whether a target 3D object is selected (S300), and control the brightness or color of the target 3D object 300a when the target 3D object is selected (S400). For example, when the target 3D object 300a is selected or the 3D indicators 210d of the effective feature points 210c are positioned in a predetermined range, the controller 110 can change the brightness of the target 3D object 300a or deepen the color of the target 3D object 300a. Also, the term “selection” as used herein can have the same meaning as the foregoing selection.

Alternatively, as a still another example of the present invention, when the target 3D object 300a is selected or the 3D indicators 210d of the effective feature points 210c are positioned in the predetermined range, audio information or video information associated with the target 3D object 300a can be output through the multimedia module 160. The audio information or the video information can be stored in advance in the storage unit 150, or can be searched for and received by the user device 100 through a real-time network.

The term “3D objects 300a, 300b, and 300c” or “target 3D object 300a” as used herein can be meant to include any one of an image, a widget, an icon, a text, and a figure, but these are illustrated as an example, and thus the term will be construed in a wide concept, including any one that can be displayed in a UI type in the user device 100.

It will be appreciated that the exemplary embodiments of the present invention can be implemented in a form of hardware, software, or a combination of hardware and software. Any such software can be stored, for example, in a volatile or non-volatile storage device such as a ROM, a memory such as a RAM, a memory chip, a memory device, or a memory IC, or a recordable optical or magnetic medium such as a CD, a DVD, a magnetic disk, or a magnetic tape, regardless of its ability to be erased or its ability to be re-recorded. A web widget manufacturing method of the present invention can be realized by a computer or a portable terminal including a controller and a memory, and it can be seen that the memory corresponds to an example of the storage medium which is suitable for storing a program or programs including instructions by which the embodiments of the present invention are realized, and is machine readable. Accordingly, the present invention includes a program for a code implementing the apparatus and method described in the appended claims of the specification and a machine (a computer or the like)-readable storage medium for storing the program. Moreover, such a program as described above can be electronically transferred through an arbitrary medium such as a communication signal transferred through cable or wireless connection, and the present invention properly includes the things equivalent to that.

Further, the device can receive the program from a program providing apparatus connected to the device wirelessly or through a wire and store the received program. The program supply apparatus may include a program that includes instructions to execute the exemplary embodiments of the present invention, a memory that stores information or the like required for the exemplary embodiments of the present invention, a communication unit that conducts wired or wireless communication with the electronic apparatus, and a control unit that transmits a corresponding program to a transmission/reception apparatus in response to the request from the electronic apparatus or automatically.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for controlling a 3-Dimensional (3D) object, the method comprising:
obtaining an image of the external object for operating at least one 3D object displayed in a user device;
extracting one or more feature points of the external object from the obtained image;
determining one or more effective feature points used for operating the at least one 3D object from the extracted feature points; and
tracing the determined effective feature points to sense an input event of the external object.

2. The method of claim 1, wherein the image is obtained through a Time of Flight (ToF) camera or a stereoscopic camera.

3. The method of claim 2, further comprising:
calculating 3D coordinates of the determined effective feature points by using depth information of the external object, which is obtained through the ToF camera or the stereoscopic camera.

4. The method of claim 1, wherein the effective feature points are determined according to the shape of the external object or in response to an input of selection by a user of the effective feature point.

5. The method of claim 1, further comprising displaying 2-Dimensional (2D) indicators corresponding to the feature points and the determined effective feature points.

6. The method of claim 5, wherein the 2D indicators are displayed on a 2D page displayed in the user device.

7. The method of claim 3, further comprising:
displaying 3D indicators corresponding to the calculated 3D coordinates of the effective feature points.

8. The method of claim 7, further comprising:
switching from the 2D page displayed in the user device into a 3D page displayed in the user device to display the 3D indicators on the 3D page.

9. The method of claim 1, wherein the input event of external object includes one or more of a touch, a tap, a swipe, a flick, and a pinch for the 3D objects or a page on which the 3D objects are displayed.

10. The method of claim 9, wherein the touch, tap, swipe, flick, and pinch are conducted while the user device in which the 3D objects are displayed is spaced apart from the external object at a predetermined interval.

11. The method of claim 1, further comprising:
increasing a size of a target 3D object, the target 3D object being selected by the effective feature points or being expected to be selected by the effective feature points in response to the input event.

12. The method of claim 1, further comprising:
changing the brightness or color of a target 3D object, the target 3D object being selected by the effective feature points or being expected to be selected by the effective feature points in response to the input event.

13. The method of claim 1, wherein the 3D object includes one or more of an image, a widget, an icon, a text, and a figure.

14. An apparatus for controlling a 3D object, the apparatus comprising:
a camera configured to obtain an image of an external object for operating 3D objects; and
a controller configured to:
extract one or more feature points of the external object from the obtained image;
determine one or more effective feature points used in operation the 3D objects from the extracted feature points; and
trace the determined effective feature points to sense an input event associated with the operation of the 3D objects.

15. The apparatus of claim 14, wherein the camera includes a Time of Flight (ToF) camera and a stereoscopic camera.

16. The apparatus of claim 15, wherein the controller is configured to calculate 3D coordinates of the determined effective feature points by using depth information of the external object, which is obtained by using the ToF camera or the stereoscopic camera.

17. The apparatus of claim 14, wherein the effective feature points are determined according to the shape of the external object or in response to the input of selection by a user of the effective feature points.

18. The apparatus of claim 14, further comprising:
a touch screen configured to display 2D indicators corresponding to the feature points and the determined effective feature points thereon.

19. The apparatus of claim 18, wherein the 2D indicators are displayed on a 2D page displayed in the user device.

20. The apparatus of claim 16, further comprising:
a touch screen configured to display 3D indicators corresponding to the calculated 3D coordinates of the effective feature points thereon.

21. The apparatus of claim 20, wherein the controller is configured to switch from the 2D page displayed in the user device into a 3D page displayed in the user device to display the 3D indicators on the 3D page.

22. The apparatus of claim 14, wherein the input event includes one or more of a touch, a tap, a swipe, a flick, and a pinch for the 3D objects or a page on which the 3D objects are displayed.

23. The apparatus of claim 22, wherein the touch, tap, swipe, flick, and pinch are conducted while a user device in which the 3D objects are displayed is spaced apart from the external object at a predetermined interval.

24. The apparatus of claim 14, wherein the controller is configured to increase a size of a target 3D object, the target 3D object being selected by the effective feature points or being expected to be selected by the effective feature points in response to the input event.

25. The apparatus of claim 14, wherein the controller is configured to change the brightness or color of a target 3D object, the target 3D object being selected by the effective feature points or being expected to be selected by the effective feature points in response to the input event.

26. The apparatus of claim 14, wherein the 3D object includes one or more of an image, a widget, an icon, a text, and a figure.
